(19) United States
(12) Patent Application Publication
(10) Pub. No.: US 2010/0088157 A1
(43) Pub. Date: Apr. 8, 2010

(54) SYSTEM AND METHOD FOR THE THROTTLED DELIVERY OF ADVERTISEMENTS AND CONTENT BASED ON A SLIDING SCALE OF USAGE

(75) Inventor: Eric S. Wilson, Los Angeles, CA (US)

Correspondence Address: SNELL & WILMER LLP (OC), 600 ANTON BOULEVARD, SUITE 1400, COSTA MESA, CA, 92626, US

(73) Assignee: SIDEBAR, INC., Santa Monica, CA (US)

(21) Appl. No.: 12/574,656

(22) Filed: Oct. 6, 2009

Related U.S. Application Data
(60) Provisional application No. 61/103,171, filed on Oct. 6, 2008.

(51) Int. Cl. G06Q 10/00; G06Q 50/00; G06Q 99/00; H04M 3/42

(52) U.S. Cl. 705/10; 455/414.1; 705/1.1

(57) ABSTRACT

A system and method for adjusting the frequency of content delivery to a communication device based on the frequency of a user's interaction with the communication device. A method of scheduling and displaying content on a communication device includes collecting data representing a user's interaction with the communication device, transmitting the data from the communication device to a scheduler, assigning the communication device to a use category, the use category assigned based on the number of interactions the user has with the communication device during a period of time, transmitting a signal to the scheduler upon an interaction with the communication device, incrementing a counter at the remote scheduler upon receiving the signal, and periodically displaying content on the communication device based on the use category and the counter.

### CLAIM OF PRIORITY UNDER 35 U.S.C. §119

The present Application for patent claims priority to Provisional Application No. 61/103,171 entitled “SYSTEM AND METHOD FOR THE THROTTLED DELIVERY OF ADVERTISEMENTS AND CONTENT BASED ON A SLIDING SCALE OF USAGE,” filed on Oct. 6, 2008, and assigned to the assignee hereof and hereby expressly incorporated by reference herein.

### BACKGROUND

1. Field

The invention relates generally to the field of content (e.g., advertisements, media, promotions, etc.). More specifically, the invention relates to a system and method for the throttled delivery of advertisements and content based on a sliding scale of usage.

2. Description of the Related Art

Improvements in communications technologies have led to an increase in the number of products/offerings provided by service providers (e.g., cable providers, internet providers, telephone companies, etc.), device manufacturers, content providers and companies offering and/or enabling value added services. Service providers offer numerous products which might include: voice services; data services such as text messaging and multimedia messaging; location based services; and internet access. Service providers also offer entertainment and a variety of content such as games, ring-tones and streaming music/video. As voice revenue diminishes and service providers become increasingly reliant on customers' use of data services and consumption of content, these service providers are continuously searching for new revenue streams to augment the declining average revenue per user (ARPU).

Wireless devices have incorporated many improvements in wireless communication technologies. For example, traditional mobile phones now feature more memory, more processing capabilities and larger screens for the viewing of content. In order to maintain and/or increase market share and revenue, device manufacturers must integrate applications/features that increase ARPU for service providers. That is, service providers may choose to integrate applications/features that are a direct or indirect source of new revenues.

The communications industry has created stiff competition amongst service providers. That is, service providers must offer new content and access to content from third party providers in order to remain competitive in the marketplace. Furthermore, service providers must aggregate or develop content that matches the interests of their customers. Moreover, service providers must transform themselves into media companies and failure to do so may result in decreasing ARPU. The cost of providing increasingly sophisticated services and content may be offset if service providers increase ARPU. Hence, service providers must persuade their customers to use more of their products to remain viable.

Automation of business practices and procedures has led many organizations to implement a business model referred to as Customer Relationship Management (CRM). CRM enables organizations to effectively promote acquisition, retention and revenue optimization through the use of reliable systems, processes and procedures. CRM calls for the automation of basic business practices and the analysis of customer behavior and communication with customers through a variety of channels.

Service providers have long recognized the need to increase ARPU. One way to increase ARPU is through targeted, unobtrusive and engaging promotions and advertising. Content providers (e.g., advertisers, brands, marketers, promoters and media companies) have long recognized the mobile communications channel as a pervasive and powerful way of connecting with their desired consumers (i.e., consumers they want to reach). Content providers have been searching for an effective model by which mobile communication devices may become a new medium to reach consumers. The invention addresses these needs by providing a system and method that advances the art.

### SUMMARY

The invention comprises a system and a method for consumer engagement and revenue optimization. The method provides for the display of content on a communication device as a result of user actions that are intended to trigger events on the device unrelated to the display of the content. The content displays as soon as the user's action is taken. The length of the display is determined by the time necessary to actuate the event and may be visible until the intended event has been actuated. In some cases, a user's action might trigger an event on another user's device. Storing the content in the memory allow the user to intentionally access the content at the user's leisure. Some content, for example, a call to action or value proposition, might be available to a user for a limited period of time or require a response within a specified period of time. Users can interact with the content at the time it is displayed, thereby interrupting the intended event, or interact with the content as a result of accessing the content within the memory. Users can share content with others through various means; the memory is a means to facilitate user interaction which may involve mobile commerce.

The system comprises a network, a management platform, and a communication device. The management platform may function as the network center for the system. The management platform may host a computer system, a database and a server. The system may be configured to communicate with providers of content, promotional sponsors and advertisers, collectively, content providers, interne and service providers, and communication devices. The system may update the database and may also store content; the database may store information about content providers. Consistent with the CRM model, the database may also store data associated with individual users or communication devices. The database is continually updated as information about individual users becomes available. The server may execute program scripts and may transmit content to and from targeted communication devices. The server may also transmit information about communication device usage and user responses which, in turn, may trigger additional content to be transmitted to targeted communication devices. A communications network may transmit data between the management platform and the communication device.

The communication device may host software that facilitates storage and presentation of content received from the management platform. Content may also be transmitted through the service provider, directly from content providers' servers, platforms, etc. The content may be displayed in real time or stored for later use. The display of content on the communication device may be the result of a user's actions that are intended to trigger events on the communication device unrelated to the display of the content.

In an embodiment, content is displayed on a communication device based on a scheduler that determines how frequently a user interacts with their communication device. Based on this usage data, the scheduler determines the frequency in which content, such as advertisements, are sent to the user's communication device. For example, a user who interacts with their communication device an average of fifty times a day will be scheduled to receive less frequent advertisements than a user who interacts with their communication device only five times day. The scheduler ensures that a frequent user will not be inundated with advertisements for the many times that they interact with their communication device. On the other hand, a less frequent user of the communication device will receive more frequent advertisements.

A communication device for scheduling and displaying content including an interaction recorder for recording a number of user interactions with the communication device during a time period, a scheduler for assigning a use category to the communication device based on the number of user interactions during the time period, a memory for storing content, and a display for displaying the content after a specified user interaction defined by the use category.

### BRIEF DESCRIPTION OF THE DRAWINGS

FIG. 1 is a block diagram of a system for scheduling and delivering content to communication or mobile devices in accordance with various embodiments of the invention;

FIG. 2 is a block diagram of a communication or mobile device in accordance with various embodiments of the invention;

FIG. 3 shows Fandango® movie content being displayed on the display of the communication device because it has the highest probability of engagement by the user in accordance with various embodiments of the invention;

FIG. 4 shows a plurality of banners displayed on the display of the communication device in accordance with various embodiments of the invention;

FIG. 5 shows a plurality of banners displayed on the display of the communication device in accordance with various embodiments of the invention;

FIG. 6 shows a plurality of alert frequencies displayed on the display of the communication device in accordance with various embodiments of the invention;

FIG. 7 shows QR scanner guide lines of the camera feature of the communication device which allows the camera to automatically focus onto and automatically capture a QR code in accordance with various embodiments of the invention;

FIG. 8 is a screen shot of the selected content being displayed on the display of the communication device in accordance with various embodiments of the invention; and

FIG. 9 is a flow diagram of a method for scheduling and delivering content to communication or mobile devices in accordance with various embodiments of the invention.

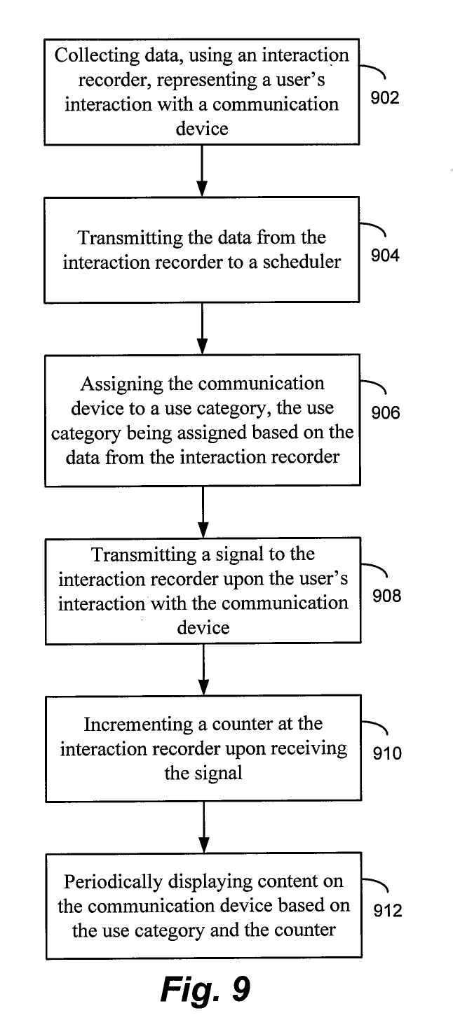

### DETAILED DESCRIPTION

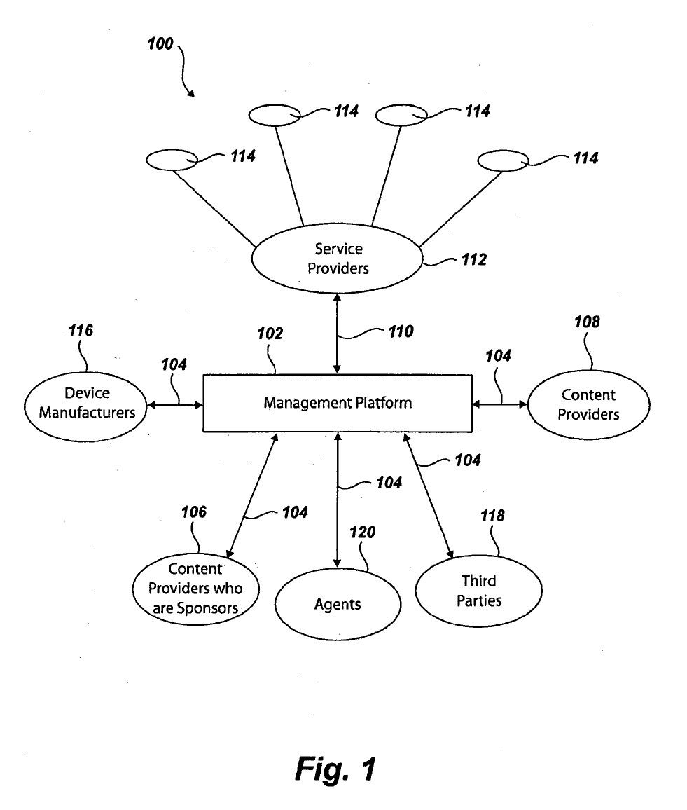

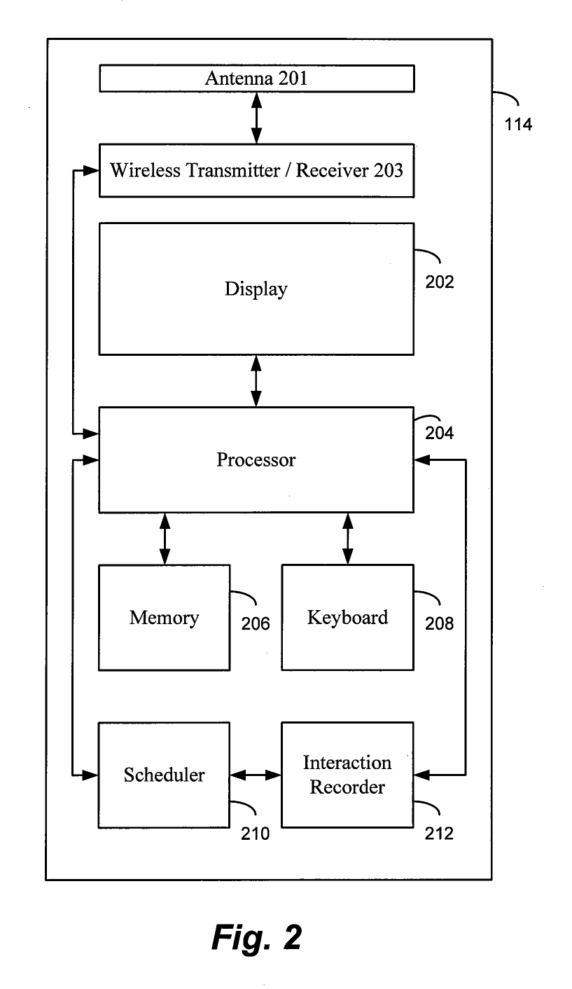

FIG. 1 is a block diagram of a system for delivering content to communication or mobile devices in accordance with various embodiments of the invention. FIG. 2 is a block diagram of a communication or mobile device 114 in accordance with various embodiments of the invention. Referring to FIGS. 1 and 2, the system 100 includes a management platform 102, content providers 106 and 108, service providers 112 and communication devices 114. The management platform 102, the content providers 106 and 108, the service providers 112 and the communication devices 114 may each have a processor 204, a memory 206, a display 202 and a keyboard 208. The processor 204 may be implemented using hardware, software, firmware, middleware, microcode, or any combination thereof. The processor 204 may be an Advanced RISC Machine (ARM), a controller, a digital signal processor (DSP), a microprocessor, an encoder, a decoder, circuitry, a processor chip, or any other device capable of processing data, and combinations thereof. The term “circuitry” may include processor circuitry, memory circuitry, RF transceiver circuitry, power circuitry, video circuitry, audio circuitry, keyboard circuitry, and display circuitry.

The memory 206 may include or store various routines and data. The term “memory” and “machine readable medium” include, but are not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The machine readable instructions may be stored in the memory 206 and may be executed by the processor 204 to cause the processor 204 to perform various functions as described in this disclosure. The display 202 may be a LCD, LED or plasma display screen and the keyboard 208 may be a standard keyboard (e.g., a QWERTY layout) having letters and numbers.

The management platform 102 functions as the nerve center of the system 100. The management platform 102 (e.g., a server) connects through the internet or other communication system 104 with content providers 108 and content providers 106 who are sponsors. The management platform 102 also connects with service providers 112 through, for example, a high bandwidth telephone line 110 (such as a T3 line), or other communication system (e.g., the internet). The content provider 108 or the service providers 112 may transmit data or content between the management platform 102 and the communication devices 114. The communication devices 114 may wireless receive the content using an antenna 201 and a wireless transmitter/receiver 203 and forward the content to the processor 204 for storage in the memory 206. The content may be received at a plurality of predetermined times.

The internet 104 may provide the primary communications channel between the management platform 102, the content providers 108 and the service providers 112. However, telephone lines, power lines, cable, satellite and mail service may also be used. The high bandwidth telephone line 110 may provide the voice and/or data channel between the management platform 102 and the service providers 112. However, the internet 104 or a dedicated fiber, power line or satellite may be used. The management platform 102 may be co-located with the service providers 112 or embedded in the service providers' 112 computer systems; it may also be centralized with an ASP server or a third party 118. The service providers 112 may communicate with the communication devices 114 through a wireless network or via the internet. However, alternate embodiments may feature wired networks with wired communication devices 114.

In an embodiment, the communication device 114 collects data representing a user's interactions with the communication device 114. Software and/or hardware installed on the communication device 114 can be used to capture these interactions. In one embodiment, an interaction recorder 212 may be used to capture these interactions. Interactions may include, but are not limited to, placing or receiving calls, sending or receiving a text or multimedia message, or browsing the Internet using a mobile browser. Each time an interaction occurs, the communication device 114 records or stores the interaction using its interaction recorder 212 (block 902). The data record of the interactions may include information such as the type of interaction (e.g., phone call, text message, Internet browsing, etc.), time of day of the interaction, duration of the interaction, and any other identifying characteristics relating to the interaction. Alternatively, the data record of the interactions can simply be an increment to a counter which tracks the number of interactions per time period (e.g., an hour, a day, a week, etc.). The data record of the interactions can be stored in the memory 206 and/or the interaction recorder 212 of the communication device 114 or, alternatively, can be stored at a remote location, such as a remote server. The data record of the interactions can be transmitted to the service providers 112 and/or the management platform 102.

On a periodic basis, the data record is transmitted to a remote scheduler (also referred to as a scheduler 210) (block 904). The remote scheduler can be located at the management platform 102, at a central location provided by the communication network provider, at a third-party location, or at the communication device 114. The data record can be sent to the remote scheduler at any pre-determined interval, such as each minute, hour, day, week, month, etc. The remote scheduler receives the data record in such frequency that it can accurately assign a use category to each communication device 114, as discussed below. Alternatively, the data record may be sent to the remote scheduler on a random basis.

In another embodiment, the data record can be sent to the remote scheduler after a pre-determined number of interactions by the user. For example, on every tenth interaction with the communication device 114, the data record is sent to the remote scheduler.

Upon receiving the data record, the remote scheduler assigns a use category to the communication device 114 (block 906). Table 1 shows exemplary values which can be used to assign the use category:

TABLE 1

| Interactions | Use Category |
|---|---|
| 0-5 | Low |
| 6-15 | Medium |
| >15 | High |

A low use category is assigned if the data record contains, for example, 0 to 5 interactions for a pre-determined period of time. For instance, the remote scheduler can be programmed to receive a data record once every hour. Upon receipt of the data record, the remote scheduler assigns a use category. In the following hour, after receiving another data record, the remote scheduler may adjust the use category if the data record shows a higher or lower number of interactions than in the previous hour.

In another embodiment, the data record can be sent to the remote scheduler once a day, i.e., once every 24 hours. Here, the remote scheduler would update the use category if the data record shows a higher or lower number of interactions than in the previous day.

Upon a user interacting with the communication device 114, the communication device 114 sends a signal to the interaction recorder 212 (block 908). For example, the signal may be triggered if the communication device 114 has a clam-shell design. When a user opens the cover, it may indicate that the user is preparing to interact with the communication device 114. In another example, the signal may be triggered if the user unlocks their communication device 114 from a locked state. Unlocking the communication device 114 may involve entering a sequence of keystrokes or verbally speaking a password into the communication device 114. The interaction recorder 212 records the action or content of each interaction, the number of interactions, and the duration of each interaction.

In another embodiment, a signal may be triggered and sent to the interaction recorder 212 upon, for example, the user pressing the “Send” button to place a call or to transmit a text message or the “End” button to end a call. Before the call is actually connected, or the text message is actually transmitted, the signal is sent to the interaction recorder 212 to record the user interacting with the communication device 114. The remote scheduler then determines based on the use category whether or not to transmit content to the communication device 114 or to display content on the display 202 of the communication device 114.

In an embodiment, the interaction recorder 212 increments a counter upon receiving a signal from the communication device 114 (block 910). The counter tracks the number of interactions a user has with the communication device 114, and uses the counter information with the data record to determine an appropriate time to transmit content to the communication device 114 or to display content on the display 202 of the communication device 114 (block 912).

Table 2 shows exemplary times of when the remote scheduler may transmit content to the communication device 114 or to display content on the display 202 of the communication device 114:

TABLE 2

| Use Category | Ad Frequency |
|---|---|
| Low | Every interaction |
| Medium | Every 3rd interaction |
| High | Every 5th interaction |

If the communication device 114 is assigned to the high use category, then the remote scheduler will transmit or display content to the communication device 114, for example, once every fifth interaction that the user has with the communication device 114. As described above, these interactions are tracked by the counter located at the interaction recorder 212. Upon the counter reaching the fifth interaction, the counter is reset to zero. Likewise, for a low use category, the remote scheduler will transmit or display content to the communication device 114 at every interaction, and the counter will be reset to zero after reaching one.

In another embodiment, the remote scheduler and the counter may be located physically (via software and/or hardware) on the communication device 114. The communication device may transmit counter information to the remote scheduler upon every increment to the counter. The remote scheduler and the counter may be implemented on the communication device 114 using software, hardware, and combinations thereof.

The values presented in Tables 1 and 2 are merely examples, and can be modified to fit a specific content delivery scheme. Furthermore, there can be numerous use categories, and this invention is not limited to just three use categories. Furthermore, the use categories can be user-defined, allowing the content delivery scheme to be highly customizable by content providers 106 and 108 and/or service providers 112.

In another embodiment, the scheduler is not remote, but rather locally housed in the communication device 114 in the form of software, hardware and/or combinations thereof. The scheduler 210 interacts with a remote data center and requests delivery of content (e.g., advertisements, media, etc.) based on a user's interaction with the communication device 114. The content may be stored in the memory 206. In one embodiment, a predetermined number of items of content are delivered or transmitted, from the management platform 102 (or the content provider 108 or the service provider 112) to the communication device 114, a predetermined number of times per day and at predetermined times and the content is stored in the memory 206 for later retrieval and display by the processor 204 based on a schedule determined by the scheduler 210. For example, it may be predetermined that the content should be delivered to each communication device 114, 4 times a day, at 5 am, noon, 5 pm, and 9 pm. In addition, 6 items of content are to be delivered to the communication device 114 at 5 am, 2 items of content are to be delivered to the communication device 114 at noon, 2 items of content are to be delivered to the communication device 114 at 5 pm, and 2 items of content are to be delivered to the communication device 114 at 9 pm.

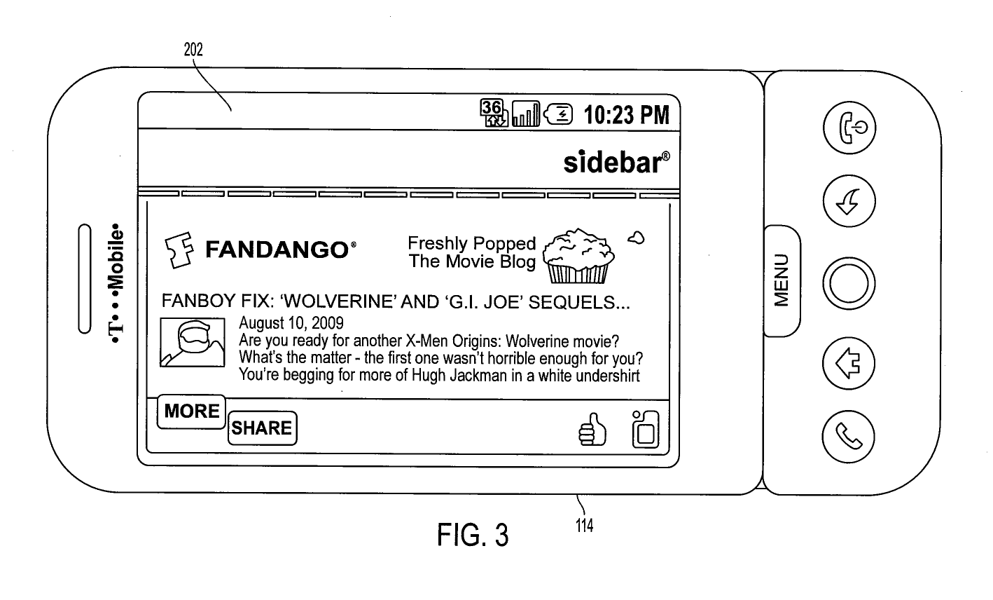

The scheduler 210 determines how often the communication device 114 should display the content and what content should be displayed based upon the user's interactions and assigned use category as described above. The scheduler 210 also determines which item is displayed based on the highest probability of engagement by the user. For example, the interaction recorder 212 may have recently recorded an interaction to a movie web site. The scheduler 210 is aware of this recent interaction and accordingly retrieves content (e.g., movie content) from the memory 206 because it has the highest probability of engagement by the user of the communication device 114. FIG. 3 shows Fandango® movie content being displayed on the display 202 of the communication device 114 because it has the highest probability of engagement by the user. The highest probability of engagement can be determined based on one or more factors such as recent interactions, most recent interaction, time of day, type of content or web site having the largest number of interactions, age or sex of the user, income level of the user, etc.

The content delivered or displayed by the remote scheduler may be advertisements relating to goods and services offered for sale, means by which to enter contests and promotions, personalized messages, content with embedded links to mobile portals, content with embedded links to the Internet or WAP pages, interactive content and content with response mechanism which enable a user to receive additional data from specific goods and service providers, or provide personal information or queries to specific goods and service providers.

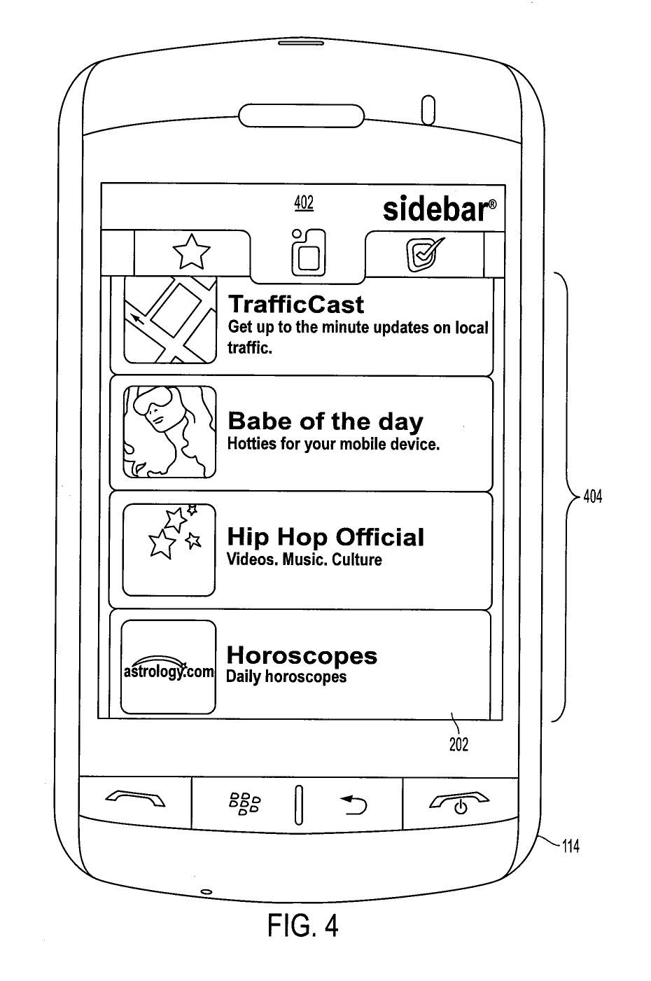

FIG. 4 shows a plurality of banners 404 displayed on the display 202 of the communication device 114 in accordance with various embodiments of the invention. A content icon or soft key 402 may be pushed or selected by the user to display the plurality of banners 404. When the content icon or soft key 402 is pushed or selected, a banner 404 for each item of content stored in the memory 206 is displayed on the display 202. The user may scroll through all the banners 404 by moving the text up or down. Using the example above, since 12 items of content are downloaded to the memory 206, 12 banners are available to view indicating that the memory 206 has 12 items of content. The plurality of banners 404 allow the user to get a brief look at each item of content stored in the memory 206 to determine whether he/she would like to view the entire contents or more details or information about the content. Clicking on a particular banner 404 retrieves the content corresponding to the banner 404 from the memory 206 and displays the content on the display 202 to allow the user to view the content. Alternatively, clicking on a particular banner 404 may also direct the user to a web site corresponding or related to the banner 404.

The display of the content may be triggered as a result of or in response to a user's designated action that is intended to trigger events on the communication device 114 that are unrelated to the display of the content. For example, the user may initiate a phone call, and during the network connection time, the content may be retrieved from the memory 206 and displayed on the display 202. This can be referred to as an alert being sent to the user to view the content. The alert may also cause the processor 204 to open an application stored in the memory 206 or access a web site. The alert may include content that the user is most likely to engage in. The content may be displayed as soon as the user's action is initiated or completed. The displayed content may disappear automatically as soon as the intended event has been actuated. In some embodiments, the length of the display may be determined by the time necessary to actuate the event; for example, the display may be visible until the intended event is actuated. In some embodiments, a user's action may trigger an event on another user's communication device 114. Storing the content in the memory 206 allow the user to intentionally access the content at the user's leisure. Some content, for example, a call to action or value proposition, might be available to a user for a limited period of time or require a response within a specified period of time. Users can interact with the content at the time it is displayed thereby interrupting the intended event, or interact with the content as a result of accessing the content within the memory 206. If the user interacts with the content, it may be displayed until the user instructs the communication device 114 to remove the content from being displayed.

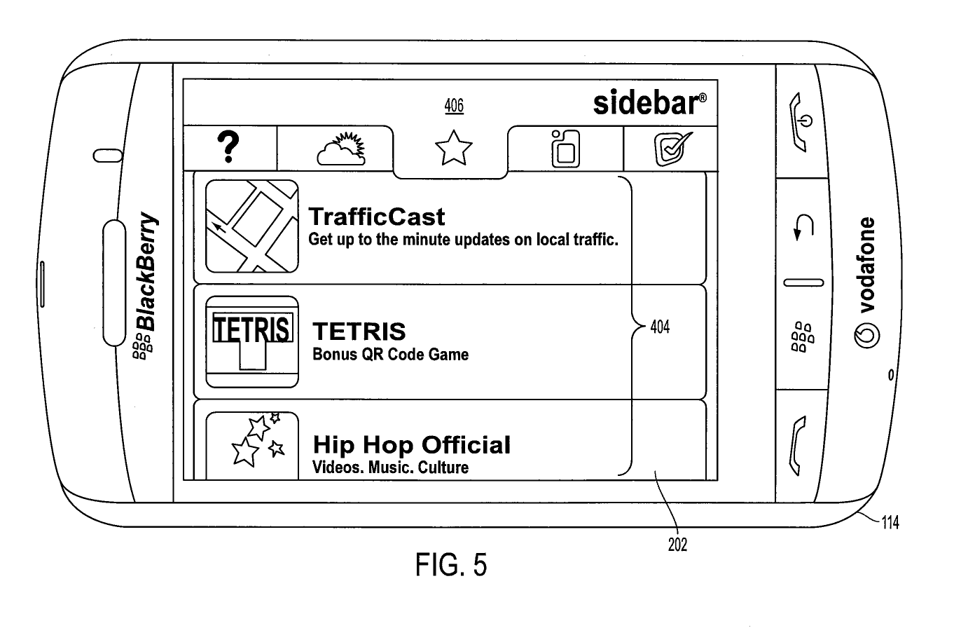

FIG. 5 shows a plurality of banners 404 displayed on the display 202 of the communication device 114 in accordance with various embodiments of the invention. A favorite icon or soft key 406 may be pushed or selected by the user to display the plurality of banners 404 that are the user's favorites. When the favorite icon or soft key 406 is pushed or selected, a banner 404 for each favorite item of content stored in the memory 206 is displayed on the display 202. The user may scroll through all the favorite banners 404 by moving the text up or down. The favorite banners 404 may be the ones that the user has clicked on in the past. The plurality of banners 404 allow the user to get a brief look at each item of content stored in the memory 206 to determine whether he/she would like to view the entire contents or more details or information about the content. Clicking on a particular banner 404 retrieves the content corresponding to the banner 404 from the memory 206 and displays the content on the display 202 to allow the user to view the content. Alternatively, clicking on a particular banner 404 may also direct the user to a web site corresponding or related to the banner 404.

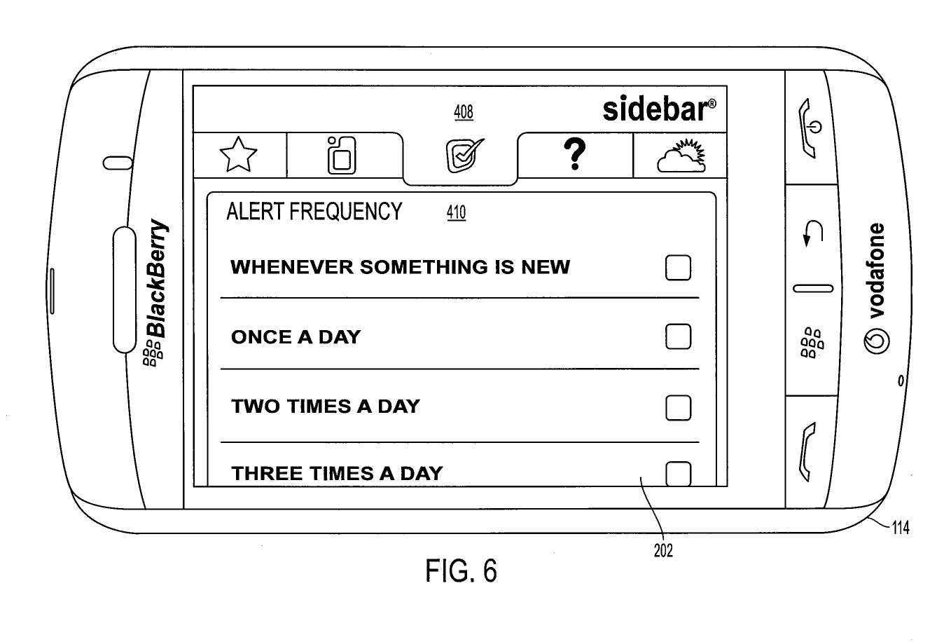

FIG. 6 shows a plurality of alert frequencies 410 displayed on the display 202 of the communication device 114 in accordance with various embodiments of the invention. A user settings icon or soft key 408 may be pushed or selected by the user to display the plurality of alert frequencies 410. When the user settings icon or soft key 408 is pushed or selected, a list of alert frequencies 410 is displayed on the display 202. The user may scroll through all the alert frequencies 410 by moving the text up or down. The plurality of alert frequencies 410 allow the user to select how often the user wants an alert or content displayed on the display 202. Clicking on a particular alert frequency 410 sets up the alert or content to be displayed according to the frequency specified.

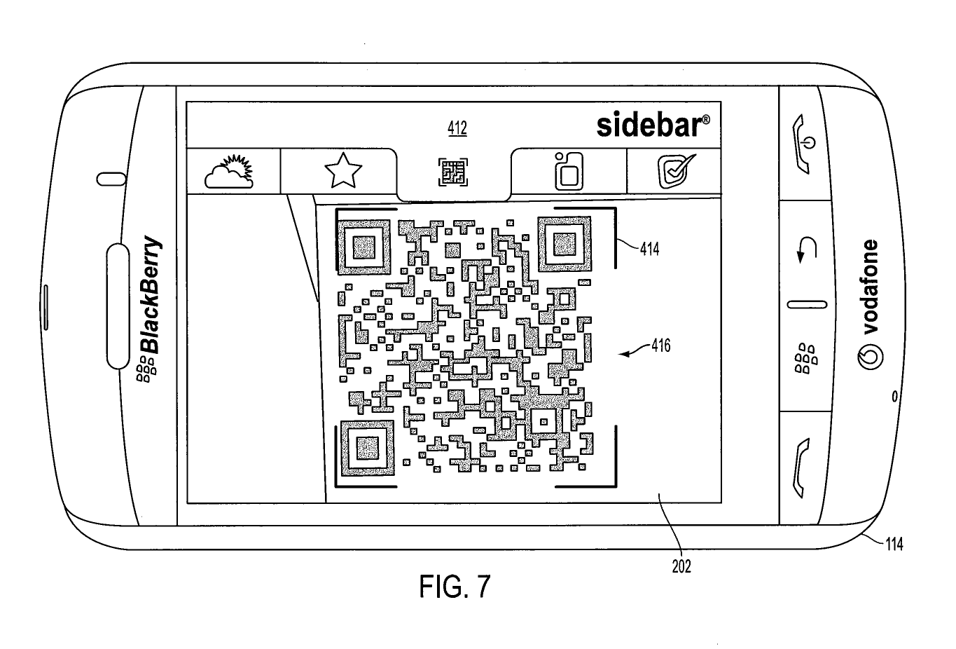

FIG. 7 shows QR scanner guide lines 414 of the camera feature of the communication device 114 which allows the camera to automatically focus onto and automatically capture a QR code 416 in accordance with various embodiments of the invention. The QR code 416 is a 2-dimensional code that can be read using QR scanner software and/or hardware. The QR code 416 can be scanned and the processor 204 can extract the data from the QR code. The processor 204 can retrieve content from its memory 204, content providers 108 and/or service providers 112 based on the QR code 416.

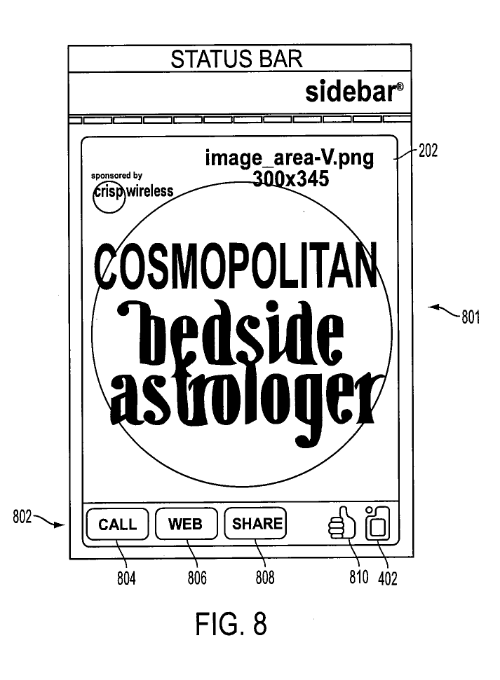

FIG. 8 is a screen shot of the selected content 801 being displayed on the display 202 of the communication device 114 in accordance with various embodiments of the invention. A plurality of action icons or soft keys 802 are displayed below the selected content 801. The plurality of action icons 802 may include a call icon 804 to place a call or send an SMS or MMS text message, a web icon 806 to access an Internet related to the content displayed on the display 202, a share icon 808 to share the content displayed with a person identified by a name or a phone number, a ratings icon 810 to rate the content displayed on the display screen 202, and the content icon 402 to display the banner 404 of content stored in the memory 206. Once selected, the rating icon 810 displays a thumbs up icon, a thumbs down icon, and an unrated icon to allow the user to select a rating for the current content being displayed on the display 202. Other icons or soft keys may be displayed such as an add icon to add the content shown on the display 202 to the memory 206, a video icon to play a video, a buy icon to buy the item displayed on the display 202, and a gift icon to gift a song, video, or item to another person identified by a name or a phone number.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of scheduling and displaying content on a communication device comprising:
collecting data representing a user's interaction with the communication device;
transmitting the data from the communication device to a scheduler;
assigning the communication device to a use category, the use category assigned based on the number of interactions the user has with the communication device during a period of time;
transmitting a signal to the scheduler upon an interaction with the communication device;
incrementing a counter at the remote scheduler upon receiving the signal; and
periodically displaying content on the communication device based on the use category and the counter.

2. The method of claim 1 wherein the user's interaction is selected from a group consisting of a placing or receiving of a call, a sending or receiving of a text or multimedia message, a browsing of the Internet using a mobile browser, a locking or unlocking of the communication device, and combinations thereof.

3. The method of claim 1 wherein the communication device is displaying content more frequently if the communication device is assigned to a low use category, and the communication device is displaying content less frequently if the communication device is assigned to a high use category.

4. A communication device for scheduling and displaying content comprising:
an interaction recorder for recording a number of user interactions with the communication device during a time period;
a scheduler for assigning a use category to the communication device based on the number of user interactions during the time period;
a memory for storing content; and
a display for displaying the content after a specified user interaction defined by the use category.

5. The communication device of claim 4 wherein the memory receives the content at a predetermined time.
